(19) United States
(12) Patent Application Publication
(10) Pub. No.: US 2023/0410006 A1
(43) Pub. Date: Dec. 21, 2023

(54) VIRTUAL DESKTOP INFRASTRUCTURE OPTIMIZATION

(71) Applicant: VMware, Inc., Palo Alto, CA (US)

(72) Inventors: Yao Zhang, Beijing (CN); Wenping Fan, Beijing (CN); Qichen Hao, Beijing (CN); Frank Stephen Taylor, London (GB); Wei Tian, Beijing (CN); Puhui Meng, Palo Alto, CA (US)

(21) Appl. No.: 17/877,661

(22) Filed: Jul. 29, 2022

Related U.S. Application Data
(63) Continuation of application No. PCT/CN2022/099361, filed on Jun. 17, 2022.

(51) Int. Cl. G06Q 10/06; G06F 9/451

(52) U.S. Cl. CPC G06Q 10/06315; G06F 9/452

(57) ABSTRACT

Disclosed are various embodiments for virtual desktop infrastructure optimization. A computing device can create a plurality of predictions for future demand for the VDI, each of the plurality of predictions using a respective one of a plurality of resource models, each representing a separate approach to predict future demand for the VDI. Then, the computing device can calculate a plurality of anticipated resource costs, each of the plurality of anticipated resource costs being based at least in part on a respective one of the plurality of predictions for future demand for the VDI. Moreover, the computing device can include, within a user interface, the plurality of predictions for future demand and the plurality of anticipated resource costs. Then, the computing device can implement a resource model from the plurality of resource models to manage an allocation of resources for the VDI in response to a selection of the resource model through the user interface.

### CROSS-REFERENCE TO RELATED APPLICATION

This application is a continuation of, and claims priority to and the benefit of, copending PCT Application No. PCT/CN2022/099361, filed on Jun. 17, 2022, with the Chinese State Intellectual Property Office.

### BACKGROUND

Like many software and infrastructure services, end-user desktop environments can be virtualized and hosted by network accessible servers (e.g., in the “cloud”). There are several benefits of virtualized, network-accessible desktop environments. First, end-user applications and software can be accessed from anywhere, using any network connected computer. Second, virtualized desktop environments are easily scalable to match the current needs of employees. Moreover, infrastructure costs can be substantially reduced as an enterprise only needs to pay for the virtualized desktops that it needs at any given time.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a pictorial diagram of an example user interface rendered by a client in the network environment of FIG. 1 according to various embodiments of the present disclosure.

FIG. 3 is a flowchart illustrating one example of functionality implemented as portions of an application executed in a computing environment in the network environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

### DETAILED DESCRIPTION

Disclosed are various approaches for modeling resource usage of virtual desktop infrastructure (VDI) in order to optimize resource allocation for the virtual desktop infrastructure. Although VDI has a number of benefits compared to providing and maintaining dedicate machines (e.g., desktops, laptops, etc.) for end users, there are a number of disadvantages. For example, if there are not enough spare virtual desktops allocated for increases in demand (e.g., additional users logging onto their virtual desktops), there can be performance hits and degradation while the end-users wait for additional virtual desktops to be made available, either due to the reallocation of a virtual desktop from another user upon logout or due to the allocation of additional resources to provide for additional virtual desktops. To prevent this performance degradation, many organizations make more virtual desktops available in any given time period than are actually needed. Unfortunately, the excess, unused virtual desktops consume additional resources for which the organization is charged. Over time, these additional charges can add up to a large sum. In some instances, over-provisioning of virtual desktops and virtual desktop resources can account for as much as 80% of an organization's usage of virtual desktops.

To solve these problems, the various embodiments of the present disclosure model different allocation strategies for virtual desktops. The different allocation models that implement these strategies have different risk/reward profiles. The lower risk allocation models are less likely to result in insufficient resource allocation with the consequence of an average higher resource consumption and average higher cost over time. In contrast, the higher risk allocation models are more likely to result in insufficient resource allocation compared to the lower risk models, but with the consequence of a lower average resource consumption and therefore a lower average cost over time.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

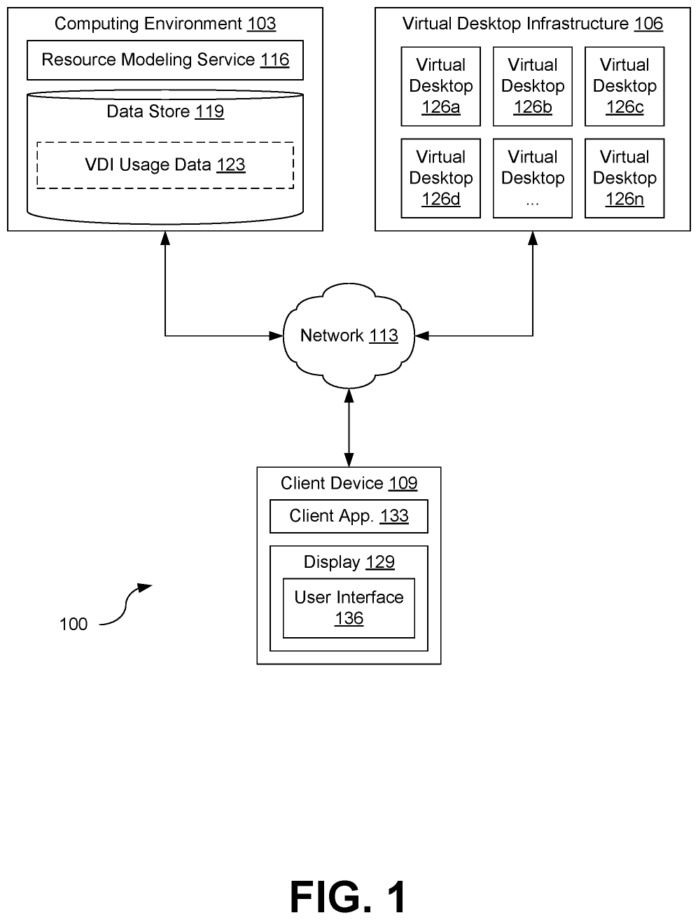

FIG. 1 depicts a network environment 100 according to various embodiments. The network environment 100 can include a computing environment 103, virtual desktop infrastructure (VDI) 106, and a client device 109. The computing environment 103, the VDI 106, and the client device 109 can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include a resource modeling service 116, and other applications, services, processes, systems, engines, or functionality not discussed in detail herein.

Also, various data is stored in a data store 119 that is accessible to the computing environment 103. The data store 119 can be representative of a plurality of data stores 119, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 119 is associated with the operation of the various applications or functional entities described below. This data can include VDI usage data 123, and potentially other data.

The resource modeling service 116 can be executed to model resource usage of the virtual desktop infrastructure 106 based at least in part on the VDI usage data 123. For example, the resource modeling service 116 can model the average, minimum, and maximum allocation of virtual desktops 126 to a tenant of the VDI 106 or other entity within a given period of time, as well as changes to the average, minimum, and maximum allocation of virtual desktops 126 over time. The resource modeling service 116 can also model how many virtual desktops 126 a tenant of the VDI 106 or other entity should allocate within a given period of time based at least in part on a preferred strategy of the tenant.

The VDI usage data 123 can represent historical usage of the virtual desktop infrastructure 106. It can include the number of virtual desktops 126 used by an organization or tenant in a given period of time, the number of unused virtual desktops 126 or type and amount of hardware resources allocated by the virtual desktop infrastructure 106 to the tenant, the cost associate with the hardware resources or virtual desktops 126 consumed by the tenant, the cost associated with the unused hardware resources or virtual desktops 126 allocated to the tenant, etc.

The virtual desktop infrastructure 106 represents one or more computing devices, which can include a processor, a memory, and/or a network interface, used to provision one or more virtual desktops 126 (e.g., virtual desktops 126a, 126b, 126c, 126d . . . 126n, etc.). In some implementations, the virtual desktop infrastructure 106 could be a multi-tenant environment that concurrently provides virtual desktops 126 for a variety of tenants and allocates hardware resources to each tenant as appropriate (e.g., in response to a tenant request for additional virtual desktops 126). These computing devices can be located in a single installation or can be distributed among many different geographical locations. For example, the virtual desktop infrastructure 106 can include a plurality of computing devices that together can include a hosted computing resource, a grid computing resource or any other distributed computing arrangement. In some cases, the virtual desktop infrastructure 106 can correspond to an elastic computing resource where the allotted capacity of processing, network, storage, or other computing-related resources can vary over time. Although depicted separately for illustrative purposes, some embodiments of the present disclosure can implement the infrastructure of the computing environment 103 and the virtual desktop infrastructure 106 as a single collection of computing devices.

Each virtual desktop 126 can represent a virtualized instance of a desktop computing environment for an end user. Virtual desktops 126 can be implemented using a variety of approaches. For example, a virtual desktop 126 could be implemented as a virtual machine with an end-user operating system installed (e.g., MICROSOFT WINDOWS, APPLE MACOS, etc.). As another example, a computing device in the virtual desktop infrastructure could allow for multiple users to connect to the same computing device. In this example, each user would be provided with a desktop environment for the duration of their session, and the computing device would share its resources among the user sessions. In any of these examples, the end user could use a remote desktop protocol (e.g., MICROSOFT Remote Desktop Protocol (RDP), APPLE Remote Desktop (ARD) protocol, VMWARE PC-over-IP (PCoIP) procotol, VMWARE BLAST protocol, etc.) to login to the virtual machine, which could display the desktop of the virtual machine on the client device 106 of the end user. User inputs (e.g., keyboard input, mouse input, etc.) could be sent from the client device to the virtual desktop 126 to operate or control applications executing on the virtual desktop.

The client device 109 is representative of a plurality of client devices that can be coupled to the network 113. The client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays 129, such as liquid crystal displays (LCDs), gas plasma-based flat panel displays, organic light emitting diode (OLED) displays, electrophoretic ink (“E-ink”) displays, projectors, or other types of display devices. In some instances, the display 129 can be a component of the client device 109 or can be connected to the client device 109 through a wired or wireless connection.

The client device 109 can be configured to execute various applications such as a client application 133 or other applications. The client application 133 can be executed in a client device 109 to access network content served up by the computing environment 103, the VDI 106, or other servers, thereby rendering a user interface 136 on the display 129. To this end, the client application 133 can include a browser, a remote desktop application, a remote access application, a dedicated application, or other executable. The user interface 136 can include a network page, an application screen, a virtualized desktop interface for a virtual desktop 126, or other user mechanism for obtaining user input. The client device 109 can be configured to execute applications beyond the client application 133 such as email applications, social networking applications, word processors, spreadsheets, or other applications.

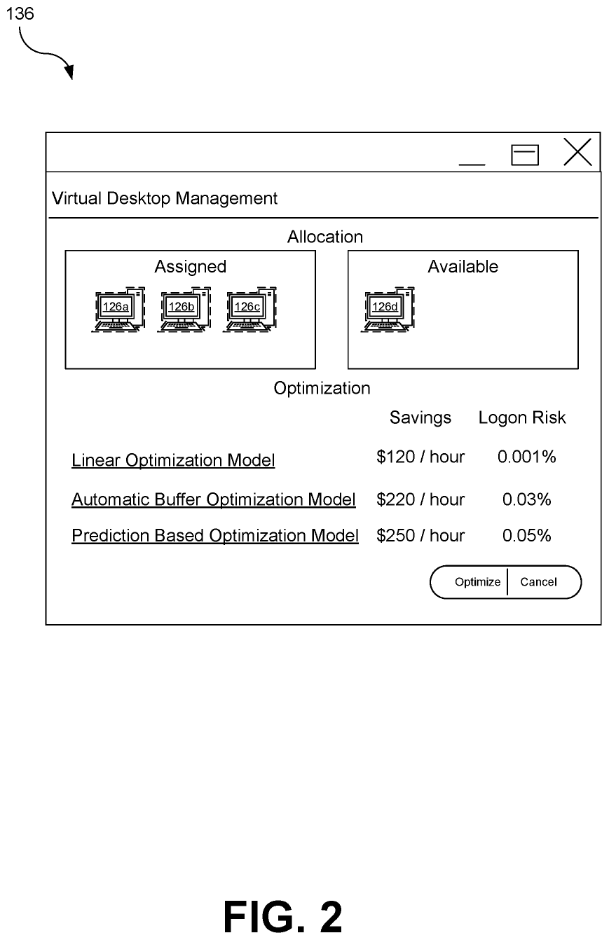

Next, a general description of the operation of the various components of the network environment 100 is provided. More detailed descriptions of the operations of the individual components are provided in the description accompanying FIGS. 2-4.

To begin, one or more tenants of the virtual desktop infrastructure 106 allocate one or more virtual desktops 126 for use by their end-users. When an end-user attempts to login to a virtual desktop 126 from his or her client device 109, the virtual desktop 126 can connect the end-user to an available virtual desktop 126 allocated to the tenant. In those instances where no virtual desktops 126 are available (e.g., because of a sudden surge of end-users attempting to logon to virtual desktops 126 in a short period of time), the virtual desktop infrastructure 106 can allocate additional virtual desktops 126. The allocation of additional virtual desktops 126 can take time while available hardware resources are identified, virtual machine instances are instantiated and booted, etc. During this time, the end-user may wait for several minutes, in worst case scenarios, to login to a virtual desktop 126. As end-users logoff from their virtual desktops 126, the virtual desktops 126 can be either decommissioned so that the tenant is not charged any further, or reset to a default state so that they remain available for other end-users.

The resource modeling service 116 can monitor and store the usage patterns of the virtual desktops 126 and virtual desktop infrastructure 106 over time. For example, the resource modeling service 116 can continuously monitor the number of virtual desktops 126 in use by or allocated to a tenant, and store this information as VDI usage data 123. This can allow the resource modeling service 116 to predict future resource needs for individual tenants of the virtual desktop infrastructure 106 using various resource models, such as a limit optimization model approach, an automatic buffer optimization model approach, or a prediction based optimization model approach. Each of these resource models will be described in further detail later.

Once sufficient VDI usage data 123 is collected, the resource modeling service 116 can present to an owner, operator, or administrator user with various resource optimization approaches. For example, the resource modeling service 116 could provide in the user interface 136 an option to allocate virtual desktops 126 using the limit optimization model approach, the automatic buffer model approach, or the prediction based optimization model approach. The resource modelling service 116 could also present the risks of each individual approach, which could be quantified as the likelihood of encountering a situation where there not sufficient virtual desktops 126 allocated, and the potential rewards of each individual approach, which could be quantified as the expected cost or cost-savings resulting from decreased consumption of virtual desktops 126.

Once the user selects a preferred resource model, the resource modeling service 116 can optimize the virtual desktops 126 allocated for the tenant. For example, with the limit optimization model approach, a constant number of virtual desktops 126 could be allocated for the tenant. Similarly, the automatic buffer model approach or the prediction based optimization model approach could change the number of virtual desktops 126 allocated as predicted changes in demand occur.

The resource modeling service 116 can continue to collect VDI usage data 123 while it implements the selected optimization solution. This can be done, for example, to enable the resource modeling service 116 to continue to update the models so that they can adapt to changes in usage patterns of the virtual desktop infrastructure 106. Accordingly, the resource modeling service 116 can periodically update or retrain the available models to take into account updated VDI usage data 123.

Referring next to FIG. 2, shown is an illustrative example of a user interface 136 according to various embodiments of the present disclosure. The user interface 136 could be generated by the client application 133 and presented on the display 129 of the client device 109 to facilitate a tenant's management of virtual desktops 126 provisioned by the virtual desktop infrastructure 106. However, other user interfaces could also be used in the various embodiments of the present disclosure.

As illustrated, the user interface 136 can present information about the virtual desktops 126 allocated to the tenant of the virtual desktop infrastructure 106. This could include information such as the number of allocated virtual desktops 126 that are currently assigned to end-users, the number of allocated virtual desktops 126 that are currently unassigned and available for end-users, etc. In some implementations, the identity of specific virtual desktops 126 could also be presented within the user interface 136.

The user interface 136 could also present the user with a list of resource models that are available to optimize the allocation of virtual desktops 126, such a limit optimization model, an automatic buffer optimization model, a prediction based optimization model, etc. Next to each resource model, the user interface 136 could present an estimated or expected cost savings using the resource model and/or the logon risk associated with using the potential resource model. The administrative user can also select one of the resource models that best applies to his or her organizations risk and cost profiles and apply it for allocating new virtual desktops 126 moving forward.

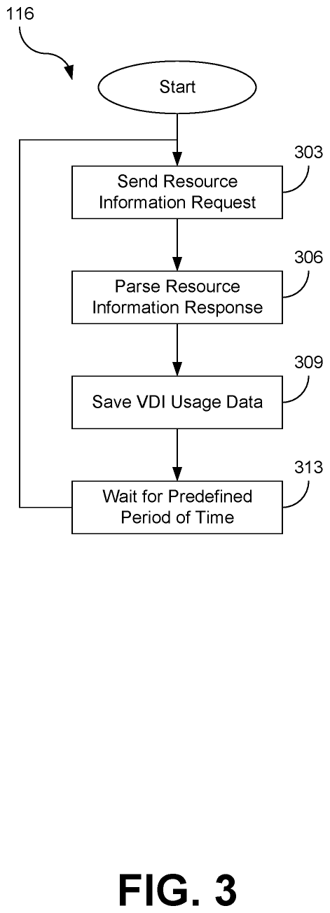

Referring next to FIG. 3, shown is a flowchart that provides one example of the operation of a portion of the resource modeling service 116. The flowchart of FIG. 3 provides merely an example of the many different types of functional arrangements that can be employed to implement the operation of the depicted portion of the resource modeling service 116. As an alternative, the flowchart of FIG. 3 can be viewed as depicting an example of elements of a method implemented within the network environment 100.

Beginning with block 303, the resource modeling service 116 can send a resource information request to the virtual desktop infrastructure 106 in order to collect VDI usage data 123. In some implementations, the resource information request could be sent to request total resource usage, while in other implementations the resource information request could be sent to request resource usage of individual tenants of the virtual desktop infrastructure 106. In some instances, a request could also be sent for total resource usage as well as resource usage on a per-tenant basis. This can be done, for example, to collect VDI usage data 123 in order to train one or more of the resource models used by the resource modeling service 116. It could also be done, for example, in order to collect additional VDI usage data 123 to update the resource models used by the resource modeling service 116. Similarly, the resource modeling service 116 could send a resource information request to the virtual desktop infrastructure 106.

Then, at block 306, the resource modeling service 116 can parse a resource information response received from the virtual desktop infrastructure 106. This can be done to allow the resource modeling service 116 to determine the number of virtual desktops 126 allocated, the number of virtual desktops 126 allocated to individual tenants, the amount of remaining resources that could be allocated for additional virtual desktops 126, etc.

Next, at block 309, the resource modeling service 116 can save the VDI usage data 123 that was extracted or parsed at block 306 from the resource information response received from the virtual desktop infrastructure 106.

Subsequently, at block 313, the resource modeling service 116 can wait for a predefined period of time (e.g., thirty seconds, one minute, 5 minutes, 10 minutes, 15 minutes, thirty minutes, one hour, etc.). Once the predefined period of time has elapsed, the process can return to block 303 to collect additional VDI usage data 123. This can allow the resource modeling service 116 to continuously and/or periodically collect VDI usage data 123.

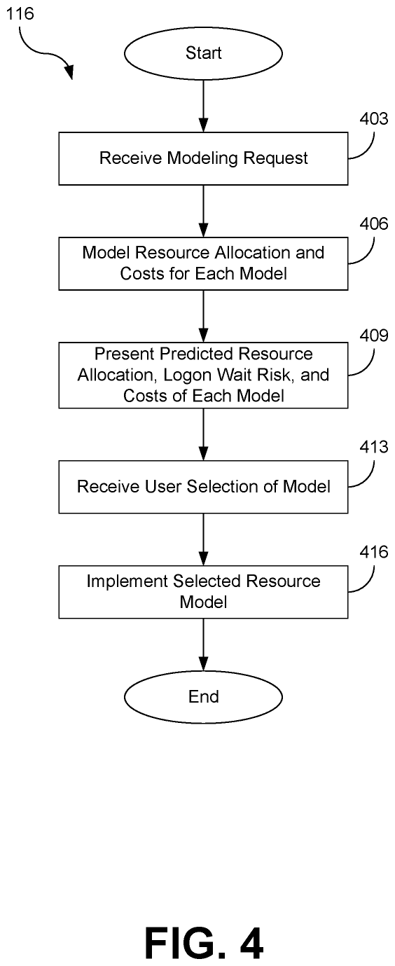

Referring next to FIG. 4, shown is a flowchart that provides one example of the operation of a portion of the resource modeling service 116. The flowchart of FIG. 4 provides merely an example of the many different types of functional arrangements that can be employed to implement the operation of the depicted portion of the resource modeling service 116. As an alternative, the flowchart of FIG. 4 can be viewed as depicting an example of elements of a method implemented within the network environment 100.

Beginning with block 403, the resource modeling service 116 can receive a modeling request. For example, an administrative user could login to a management console provided by the virtual desktop infrastructure 106 or by the resource modeling service 116. The administrative user could then select or manipulate the user interface 136 presented on the display 129 of the client device 109 to send a request to the resource modeling service 116. The modeling request could also include options or criteria, such as modeling costs and resource consumption for specified period or window of time, etc.

At block 406, the resource modeling service 116 can model the resource allocation and costs for the administrative user using one or more or more resource models. In the event that multiple resource models are used, the resource modeling service 116 could use each of the models to provide alternative predictions of costs for various resource allocations to handle anticipated demand for virtual desktops 126. For example, the resource modeling service 116 could use historical VDI usage data 123 associated with the tenant managed by the administrative user to predict the number of virtual desktops 126 utilized by the tenant over time, the number of virtual desktops 126 that should be allocated to the tenant over time, and/or the costs associated with allocating the predicted number of virtual desktops 126 to the tenant. As previously discussed, the appropriate amount of resources allocated to the tenant could be modeled using a number of approaches. As each approach has a separate risk profile, each approach could be modeled and the results of each resource model could be presented to the administrative user.

Formally speaking, given the workload sequence x_{t,n}=(xₜ; . . . ; xₜ₋ₙ₊₁) virtual desktop infrastructure 106, where xₜ denotes the value of the workload at time t (in minutes) and n denotes the workload sequence length, an optimization model can be built with f_{Δt}: x_{t,n}→R, with which one can acquire a virtual desktop 126 that should be allocated on \tilde{x}ₜ at time t as \tilde{x}ₜ=f(xₜ,n). The target of an optimization model is to minimize \tilde{x}ₜ, which will induce a minimum cost. But insufficient \tilde{x}ₜ may cause end users of virtual desktops 126 to wait for desktop preparation in logon, which can take several minutes while a new virtual desktop is initiated, launches various preinstalled or preconfigured applications or agents, executes user-defined scripts, etc. Formally speaking, given the maximum time Δt¹ used to prepare a virtual desktop 126, all virtual desktops 126 initiated on \tilde{x}ₜ will ultimately complete preparation at time t+Δt. These additional virtual desktops 126 can then fulfill any capacity requirements at t+Δt, which can be expressed as \tilde{x}ₜ≥xₜ+Δt.

Accordingly, any resource model used by the resource modeling service 116 can be expressed as a minimization problem. Although different approaches could be used to solve the minimization problem, the minimization problem can be expressed as minimizing the login wait risk possibility to a minimal level, expressed as

min(f_{Δt}(xₜ,n))s.t. P(xₜ+Δt≥f_{Δt}(xₜ,n))<∈,∈∈(0,1)

where P denotes statistical possibility and ∈ is a very small number (e.g., 10⁻⁵ or a similarly small number), which could be provided as a hyper parameter or a user specified parameter.

For example, the resource modeling service 116 could use a limit optimization model to predict the number of virtual desktops 126 typically used by the tenant and the appropriate number of virtual desktops 126 to allocate to the tenant. Using the limit optimization model, the resource modeling service 116 could determine the statistical maximum x̅_{∈} which satisfies the condition that xₜ will exceed x̅_{∈} with probability ∈. To simplify the limit optimization model, the daily maximum workload could be assumed to be in a Gaussian distribution, such that the value of x̅_{∈}, can be calculated using equation (1).

$${flimit ( {x}_{t} )}_{Δ t} = {\overline{x}}_{ϵ} , where P ( {x}_{t} + Δ t \geq {\overline{x}}_{ϵ} ) < ϵ , ϵ ∈ ( 0 , 1 ) \qquad ( 1 )$$

As a result, the resource modeling service 116 is able to estimate the minimum, constant total number of virtual desktops 126 to allocate to the tenant with a minimal probability of being exceed. For example, if a tenant typically uses between 30-50 virtual desktops 126 in any given period of time, but regularly experiences peaks where as many as 95 virtual desktops 126 are used by the tenant, the limit optimization model could calculate that 100 virtual desktops 126 should always be allocated to the tenant to ensure sufficient capacity at any given time.

As another example, the resource modeling service 116 could use an automatic buffer optimization model, which can be used with a gradient workload trend. Given the maximum time Δt used to prepare a virtual desktop 126, the logon speed can be defined as Δx_{Δt}=xₜ−x_{t-Δt}. Given the statistical up-limit of session logon speed Δ̅x̅_{Δt,∈} with which Δx_{Δt} exceeding Δ̅x̅_{Δt,∈} with probability ∈, the session count at time t+Δt would be no more than xₜ+Δ̅x̅_{Δt,∈} with probability 1−∈. Accordingly, Δ̅x̅_{Δt,∈} could be utilized as a static buffer for assignments of virtual desktops 126.

To avoid the impact of data jitter caused by delays in data collection by the resource modeling service 116, the look ahead window could be extended from Δt to δ(δ≥Δt) (δ is a hyper-parameter), and adopt the maximum value of future (δ−Δt) data points to further reduce the logon wait risk using equation (2).

$${f buffer ( {x}_{t , n} )}_{Δ t} = {{max}_{τ = t - ( δ - Δ t )}}^{t} ( {x}_{τ} + {\overline{Δ x}}_{δ , ϵ} ) \qquad ( 2 )$$

$$where P [ ( {x}_{t + δ} - {x}_{t} ) \geq {\overline{Δ x}}_{δ , ϵ} ] < ϵ , δ \geq Δ t , ϵ ∈ ( 0 , 1 )$$

Alternatively, a prediction based optimization model (which can be treated as a version of the automatic buffer optimization model) can be used. The prediction based optimization model can adapt the buffer virtual desktops 126 based at least in part on a prediction of the future workload. While the automatic buffer optimization model creates a buffer based on current usage, the prediction based optimization model creates a buffer of virtual desktops 126 based on predicted future usage. For example, the prediction based optimization model could utilize a workload prediction model, referred to herein as WP, to predict future workloads. The workload prediction model could use global trends, recent fluctuations, and seasonal patterns in virtual desktop 126 usage to precisely predict the workload \hat{x}_{t+δ} for a predefined period of time in the future (e.g., 30 minutes, 60 minutes, etc.). For example, given the prediction interval δ, the workload prediction \hat{x}_{t+δ} can be inferred by WP_{δ}, which could be trained using the VDI usage data 123. Accordingly, Ass can be defined as the under predict value. A positive Δ\hat{x}_{δ}(Δ\hat{x}_{δ}>0) indicates that a virtual desktop user will endure the logon wait if the predicted workload \hat{x}_{t+δ} is employed as number of allocated virtual desktops 126 at time t+δ, as given in equation (3) below.

\hat{x}_{t+δ}=WP_{δ}(x_{t,n})

Δ\hat{x}_{t+δ}=x_{t+δ}−\hat{x}_{t+δ} (3)

To control the logon wait risk under Σ, an extra statistical WP under-predict maximum \overline{Δ\hat{x}}_{δ,∈} can be added to the predicted workload. Therefore, the workload in future δ minutes can exceed the predicted number of allocated virtual desktops 126 with probability Σ. Similarly to the automatic buffer optimization approach, the max value of future (δ−Δt) minutes for the predicted workload can be used to further reduce the logon wait risk, as given in equation (4) below:

$${f}_{Δ t}^{prediction} ( {x}_{t , n} ) = {{max}_{τ = t - ( δ - Δ t )}}^{t} ( {WP}_{δ} ( {x}_{τ , n} ) + {\overline{Δ \hat{x}}}_{δ , ϵ} ) , \qquad ( 7 )$$

$$where P [ ( {x}_{t + δ} - {WP}_{δ} ( {x}_{τ , n} ) ) \geq {\overline{Δ \hat{x}}}_{δ , ϵ} ] < ϵ ,$$

$$δ \geq Δ t , ϵ ∈ ( 0 , 1 ) .$$

Then, at block 409, the resource modeling service 116 can present the predicted resource allocations and predicted costs to the administrative user, as well as the logon wait risk associated with each predicted resource allocation. For example, for each model used by the resource modeling service 116, the resource modeling service 116 could send the predicted resource allocation, predicted logon wait risk, and predicted cost to the client application 133, which could then present the results within the user interface on the display. This would allow the administrative user to determine which model would be most appropriate to use for allocating virtual desktops 126 for the tenant based on the cost sensitivity and the risk tolerance of the tenant.

Subsequently, at block 413, the resource modeling service 116 can receive a user selection from the client application 133 on the client device 109 indicating which model should be used for allocating virtual desktops 126 for the tenant.

Moving on to block 416, the resource modeling service 116 can then update the resource allocations for the tenant of the virtual desktop infrastructure 106 based at least in part on the user selected model. For example, the resource modelling service 116 could send a message to the virtual desktop infrastructure 106 to allocate a set number of virtual desktops 126 to a tenant if the administrative user had selected to use a limit optimization model in order to allocate virtual desktops 126 with a minimum logon risk. The virtual desktop infrastructure 106 could then allocate the appropriate number of virtual desktops 126. As another example, the resource modeling service 116 could send periodic messages to update the allocation of virtual desktops 126 in response to current usage by the tenant. For example, if the administrative user selected an automatic buffer optimization model or a prediction based optimization model, the resource modeling service 116 could send messages to update the allocation of virtual desktops 126 to the tenant based at least in part on the current or predicted resource usage of the tenant. In response, the virtual desktop infrastructure 106 could increase or decrease the number of virtual desktops 126 allocated to the tenant based at least in part on the prediction of the resource model.

Alternatively, at block 416, the resource modeling service 116 could instead provide the selected optimization model to the virtual desktop infrastructure 106. The virtual desktop infrastructure 106 could then allocate an appropriate number of virtual desktops 126 to the tenant at any given time based at least in part on the number of virtual desktops 126 that the resource model predicts for the given period of time. As each period of time passes, the virtual desktop infrastructure 106 could

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
create a plurality of predictions for future demand for virtual desktop infrastructure (VDI), each of the plurality of predictions for future demand being created using a respective one of a plurality of resource models, each of the plurality of resource models representing a separate approach to predict future demand for the VDI;
calculate a plurality of anticipated resource costs, each of the plurality of anticipated resource costs being based at least in part on a respective one of the plurality of predictions for future demand for the VDI;
calculate a respective logon wait risk for each of the plurality of predictions for future demand;
include, within a user interface, the plurality of predictions for future demand for the VDI, the respective logon wait risk for each of the plurality of predictions for future demand, and the plurality of anticipated resource costs for each of the plurality of resource models; and
implement a resource model from the plurality of resource models to manage an allocation of resources for the VDI in response to a selection of the resource model through the user interface.

2. The system of claim 1, wherein the machine-readable instructions that cause the computing device to create the plurality of resource models further cause the computing device to at least:
collect historical usage data for the VDI; and
train each of the plurality of resource models based at least in part on the historical usage data for the VDI.

3. The system of claim 1, wherein the machine-readable instructions that cause the computing device to implement the resource model to manage the allocation of resources for the VDI further cause the computing device to at least:
periodically determine, based at least in part on the resource model, a number of virtual desktops needed; and
adjust the allocation of resources for the VDI based at least in part on the number of virtual desktops needed.

4. The system of claim 1, wherein the machine-readable instructions further cause the computing device to at least include, within a user interface, a current number of virtual desktops assigned to end-users and a current number of virtual desktops available to end-users.

5. The system of claim 1, wherein at least one of the plurality of resource models is a limit-optimization model.

6. The system of claim 1, wherein at least one of the plurality of resource models is an automatic buffer optimization model.

7. The system of claim 1, wherein at least one of the plurality of resource models is a prediction based optimization model.

8. A method, comprising:
creating a plurality of predictions for future demand for virtual desktop infrastructure (VDI), each of the plurality of predictions for future demand being created using a respective one of a plurality of resource models, each of the plurality of resource models representing a separate approach to predict future demand for the VDI;
calculating a plurality of anticipated resource costs, each of the plurality of anticipated resource costs being based at least in part on a respective one of the plurality of predictions for future demand for the VDI;
calculating a respective logon wait risk for each of the plurality of predictions for future demand;
including, within a user interface, the plurality of predictions for future demand for the VDI, the respective logon wait risk for each of the plurality of predictions for future demand, and the plurality of anticipated resource costs for each of the plurality of resource models; and
implementing a resource model from the plurality of resource models to manage an allocation of resources for the VDI in response to a selection of the resource model through the user interface.

9. The method of claim 8, wherein creating the plurality of resource models further comprises:
collecting historical usage data for the VDI; and
training each of the plurality of resource models based at least in part on the historical usage data for the VDI.

10. The method of claim 8, wherein implementing the resource model to manage the allocation of resources for the VDI further comprises:
periodically determining, based at least in part on the resource model, a number of virtual desktops needed; and
adjusting the allocation of resources for the VDI based at least in part on the number of virtual desktops needed.

11. The method of claim 8, further comprising including, within a user interface, a current number of virtual desktops assigned to end-users and a current number of virtual desktops available to end-users.

12. The method of claim 8, wherein at least one of the plurality of resource models is a limit-optimization model.

13. The method of claim 8, wherein at least one of the plurality of resource models is an automatic buffer optimization model.

14. The method of claim 8, wherein at least one of the plurality of resource models is a prediction based optimization model.

15. A non-transitory, computer-readable medium, comprising machine-readable instructions that, when executed by a processor of a computing device, cause the computing device to at least:
create a plurality of predictions for future demand for virtual desktop infrastructure (VDI), each of the plurality of predictions for future demand being created using a respective one of a plurality of resource models, each of the plurality of resource models representing a separate approach to predict future demand for the VDI;
calculate a plurality of anticipated resource costs, each of the plurality of anticipated resource costs being based at least in part on a respective one of the plurality of predictions for future demand for the VDI;
calculate a respective logon wait risk for each of the plurality of predictions for future demand;
include, within a user interface, the plurality of predictions for future demand for the VDI, the respective logon wait risk for each of the plurality of predictions for future demand, and the plurality of anticipated resource costs for each of the plurality of resource models; and
implement a resource model from the plurality of resource models to manage an allocation of resources for the VDI in response to a selection of the resource model through the user interface.

16. The non-transitory, computer-readable medium of claim 15, wherein the machine-readable instructions that cause the computing device to create the plurality of resource models further cause the computing device to at least:
collect historical usage data for the VDI; and
train each of the plurality of resource models based at least in part on the historical usage data for the VDI.

17. The non-transitory, computer-readable medium of claim 15, wherein the machine-readable instructions that cause the computing device to implement the resource model to manage the allocation of resources for the VDI further cause the computing device to at least:
periodically determine, based at least in part on the resource model, a number of virtual desktops needed; and
adjust the allocation of resources for the VDI based at least in part on the number of virtual desktops needed.

18. The non-transitory, computer-readable medium of claim 15, wherein at least one of the plurality of resource models is a limit-optimization model.

19. The non-transitory, computer-readable medium of claim 15, wherein at least one of the plurality of resource models is an automatic buffer optimization model.

20. The non-transitory, computer-readable medium of claim 15, wherein at least one of the plurality of resource models is a prediction based optimization model.
